(19) United States
(12) Patent Application Publication
(10) Pub. No.: US 2025/0087112 A1
(43) Pub. Date: Mar. 13, 2025

(54) ML-Driven Extension to Predict Visually Impaired Spectrum

(71) Applicant: Capital One Services, LLC, McLean, VA (US)

(72) Inventors: Tania Cruz Morales, Washington, DC (US); Kevin Lowe, Richmond, VA (US); Sonia Sierra Sillero, Pacifica, CA (US)

(73) Assignee: Capital One Services, LLC, McLean, VA (US)

(21) Appl. No.: 18/244,485

(22) Filed: Sep. 11, 2023

(51) Int. Cl. G09B 21/00; G06F 3/04847; G06F 3/0485; G06F 40/109; G10L 15/22

(52) U.S. Cl. CPC G09B 21/008; G06F 3/04847; G06F 3/0485; G06F 40/109; G09B 21/006; G10L 15/22

(57) ABSTRACT

Methods, systems, and apparatuses are described herein for an extension that predicts a user's Visually Impaired Spectrum (VIS) score then adjusts a browser accessibility setting accordingly. Further, the method may monitor the user's interaction with the accessibility settings and update the user's predicted VIS score. An extension may train a machine learning model to predict a user's VIS score, then generate a VIS score employing the user's personal information as input. Further, the extension may retrieve, from a database, one or more accessibility settings associated with a VIS score. The extension may adjust one or more browser accessibility settings according to the VIS score.

### TECHNICAL FIELD

Aspects of the disclosure relate generally to adjusting one or more browser settings according to a user's visually impaired spectrum score. More specifically, aspects of the disclosure may provide for improvements to predicting, using a trained machine learning model, a user's visually impaired spectrum score by, in part, monitoring how a user adjusts one or more browser settings.

### BACKGROUND OF THE INVENTION

Many visual impairments manifest as partial vision or vision that diminishes over time. For example, users with macular degeneration often experience dark spots in the center of their vision, frustrating reading. Users suffering from glaucoma may experience slowly diminishing vision ending in total blindness, sometimes taking over ten years. Many visual impairments cannot be corrected using prescription glasses; therefore, many users turn to electronic reading aids for assistance in reading electronic documents. Current electronic reading aids are designed mainly for the completely visually impaired and are not adaptable to a user's unique visual ability and/or degenerative vision. Consequently, electronic reading aids are not helpful for users experiencing partial or individual visual impairment. Therefore, there is a need to develop improved electronic reading aids that may accurately analyze the user's current vision ability and adjust one or more display settings appropriately.

Aspects described herein may address these and other problems, and generally improve the quality, efficiency, accessibility, and usability of electronic reading aids by predicting a user's current visual impairment score and automatically adjusting one or more accessibility settings accordingly.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow an extension to automatically adjust one or more browser accessibility settings when presenting a readable document on the browser. One or more accessibility settings may be adjusted based on a predicted first visually impaired spectrum score associated with a user. The first visually impaired spectrum score associated with the user may be predicted by a first trained machine learning model, which may be trained to predict a visually impaired spectrum score. The first trained machine learning model may predict a first visually impaired spectrum score associated with the user using the personal information associated with the user as input. For example, past user interactions indicating a preferred one or more accessibility settings, such as a preferred auto-scrolling speed and/or a preferred text-to-speech conversion rate, may be used as input to the first trained machine learning model to predict the first visually impaired spectrum score associated with the user.

Based on the predicted user's visually impaired spectrum score, the extension may retrieve information regarding appropriate accessibility settings for the user's visually impaired spectrum score and adjust one or more accessibility settings accordingly. After the extension adjusts, based on the user's visually impaired spectrum score, the one or more accessibility settings, the extension may receive feedback from the user regarding the helpfulness of the adjusted one or more accessibility settings. The feedback may be used as input to the first trained machine learning model to predict a second visually impaired spectrum score. The browser may further adjust the adjusted one or more accessibility settings according to the second visually impaired spectrum score. In this way, the extension may monitor the user's visual impairment over time and automatically adjust one or more accessibility settings accordingly.

More particularly, a computing device may train, based on browser interaction data, a first machine learning model to predict a visually impaired spectrum score. The computing device may then generate, by an extension implementing the first trained machine learning model, a first visually impaired spectrum score associated with a user. Next, the computing device may adjust, by the extension and based on the first visually impaired spectrum score, one or more accessibility settings of a browser executing the extension. After adjusting the one or more accessibility settings, the computing device may receive, by a second trained machine learning model, feedback from the user regarding an adjustment to the one or more accessibility settings. Further, the feedback comprises one or more of verbal user feedback or a response to a displayed prompt. Then the computing device may adjust, by the extension and based on feedback from the user, at least one accessibility setting of the one or more accessibility settings. Additionally, the computing device may store the at least one adjusted accessibility setting, and cause, by the browser and using the at least one adjusted accessibility setting, presentation of a webpage and/or readable document on the browser.

Additionally, the computing device may determine, by the server and based on the first visually impaired spectrum score, one or more additional accessibility settings associated with the first visually impaired spectrum score; and adjust, by the extension, the one or more additional accessibility settings of the browser. Further, the computing device may receive additional feedback from the user regarding the adjustment to the one or more additional accessibility settings. Additionally, the computing device may store, based on the additional feedback, the one or more adjusted additional accessibility settings. Then the computing device may cause, by the extension and based on the additional feedback, presentation of the readable document on the browser using the one or more adjusted additional accessibility settings.

In some instances, the computing device may cause, by the server based on the additional feedback and the first visually impaired spectrum score, a notification to be displayed to the user reflecting a change in the first visually impaired spectrum score. Further, the computing device may automatically perform, based on detecting the user interacting with the readable document, the one or more adjusted additional accessibility settings.

Further, the computing device may implement a second trained machine learning model, such as one or more speech recognition models. The second trained machine learning model may use, as input, the user feedback regarding the adjusted one or more accessibility settings.

Additionally, the computing device may automatically perform, based on detecting the user interacting with a readable document on the webpage, auto-scrolling of the readable document based on the one or more adjusted accessibility settings. Additionally, the computing device may automatically perform, based on detecting the user interacting with the readable document, text-to-speech conversion of the readable document based on the one or more adjusted accessibility settings.

When generating the first visually impaired spectrum score, the computing device may receive, by the extension, past user interactions indicating at least one of a preferred auto-scrolling speed for the user or a preferred text-to-speech conversion rate for the user. Further, the computing device may generate, based on the past user interactions, the first visually impaired spectrum score. Additionally, the computing device may determine, based on the first visually impaired spectrum score, one or more additional accessibility settings associated with the first visually impaired spectrum score. Further, the computing device may prompt, based on determining one or more reading aids, the user to enable the one or more reading aids.

The one or more accessibility settings may comprise one or more of: a font size, a font color, a font selection, a font spacing, a background color, a foreground color, a background pattern, a foreground pattern, a document lighting characteristic, a spotlight illumination characteristic, a magnification level, an animation characteristic, a transparency percentage, a tactile feedback setting, an auto-scrolling speed of the browser, or a text-to-speech conversion rate of the browser. The one or more accessibility settings may be associated with a readable document comprising text data. Additionally and/or alternatively, the one or more accessibility settings may be associated with an image related document. Image related documents may comprise pictures, videos, and/or other image data.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2. depicts an example deep neural network architecture for a model according to one or more aspects of the disclosure;

FIG. 3 depicts a flow chart for a method for predicting a first visually impaired spectrum score;

FIG. 4 depicts s a flow chart for automatically adjusting one or more accessibility setting based on monitoring a user's interactions with a browser;

FIG. 5 depicts a flow chart for a method for predicting a second visually impaired spectrum score;

FIG. 6A, FIG. 6B, and FIG. 6C are examples of an interface with adjusted accessibility settings; and

FIG. 7 is an example of an interface for verifying the adjusted one or more accessibility settings.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for automatically providing, by an extension, one or more accessibility settings when the user is interacting with a readable document. The one or more accessibility settings may be associated with the user's current visual abilities. For example, the user may be experiencing one or more visual impairments that result in partial vision. Further, the one or more visual impairments may be temporary, permanent, or may change over time. A machine learning model may be trained to predict a visually impaired spectrum score by using personal data and/or previously generated training data sets. The trained machine learning model may receive, as input, user's personal data and/or user's previous interactions with a browser. After receiving input data, the trained machine learning model may generate a first visually impaired spectrum score associated with the user's visual impairments. The extension may retrieve information regarding accessibility settings associated with the first visually impaired spectrum score. Then the extension may display a readable document using the retrieved accessibility settings. The extension may provide a message to the user requesting feedback related to the accessibility settings. The user may provide feedback on the accessibility settings using, for example, a chat box or other user input method. For example, the user may request further adjustments to the accessibility settings or indicate that the current accessibility settings are effective and appropriate. The feedback may be provided to the trained machine learning model as a feedback loop to further train and/or update the machine learning model.

As an example of how the present disclosure may operate, an extension may use a trained machine learning algorithm to predict a user's visually impaired spectrum score. The visually impaired spectrum score may determine one or more accessibility settings that would best aid the user when reading a document. For example, a user may have inherited Retinitis Pigmentosa (RP), a progressive retinal degenerative disease. Users with RP may experience loss of night vision, tunnel vision, loss of central vision, and/or have difficulties seeing different colors. Each of these eye problems may require one or more particular accessibility settings to enable the user to interact with a document. Further, as RP is degenerative, the eye problems associated with the user may increase and develop over time requiring further accessibility setting adjustments. For example, the user may first experience night blindness (“loss of night vision”). Adjusting the brightness and/or color of the browser screen may aid in allowing the user to read a document independently. As the night blindness increases and/or the user experiences other RP eye problems, the adjustments to the brightness and/or color of the browser screen may need updating for the user to continue reading independently.

Further, the extension may monitor the user's interaction with a readable document as the disease progresses over time. For example, the extension may determine that the user is decreasing an auto-scroll rate and/or adjusting the font size. The extension may send these user adjusted accessibility settings as input to the trained machine learning model to predict a second visually impaired spectrum score. The extension may then adjust the accessibility settings according to the second visually impaired spectrum score. Further, the extension may determine that a difference between the second visually impaired spectrum score and the first visually impaired spectrum score satisfies a threshold, which may indicate a further development in the user's degenerative visual impairment. The extension may notify the user that the difference between the second visually impaired spectrum score and the first visually impaired spectrum score satisfies the threshold.

In some instances, the extension described herein may act as a screen reader for a user who, while not completely blind, may require aid to read a document. Current screen readers disregard users who may have a spectrum of challenges when it comes to reading, forcing users to use the screen readers as-is. This may frustrate the user as, for example, the screen reader will not enable a blind user to scroll a website. Further, current screen readers are not able to adaptively modify to fluctuating or deteriorating vision over time. Therefore, there is a need to develop dynamic electronic tools to assist users in accomplishing their goals according to the user's ability.

Aspects described herein improve the functioning of computers by providing a method of uniquely displaying content on an electronic device, such as a website, graphical user interface (GUI), computer screen, and other electronic devices. Current traditional electronic reading aid software fails to include accessibility settings configured for users with partial and/or degenerative visual impairments. By using a trained machine learning model and user-specific data as input, an extension may determine one or more optimal accessibility settings, unique to the currently visual needs of the user. Automatically displaying reading documents with the optimal accessibility settings, unique to the user, comprises the technological improvement to how computers display documents, a well-known function of computers.

Further, by monitoring the user's interaction with the readable document over time, the extension may determine a change to the user's visual impairment and update the accessibility settings accordingly. To that end, the extension may track the changes to the user's visual impairment and determine that the change to the user's visual impairment warrants a notification to the user. In automatically displaying a readable document using modified accessibility settings unique the user, the current disclosure is tied to the practical application of providing adaptable accessibility settings of an electronic reading aid. Further, determining and notifying a user of changes in their visual impairments is a further practical application of the current disclosure.

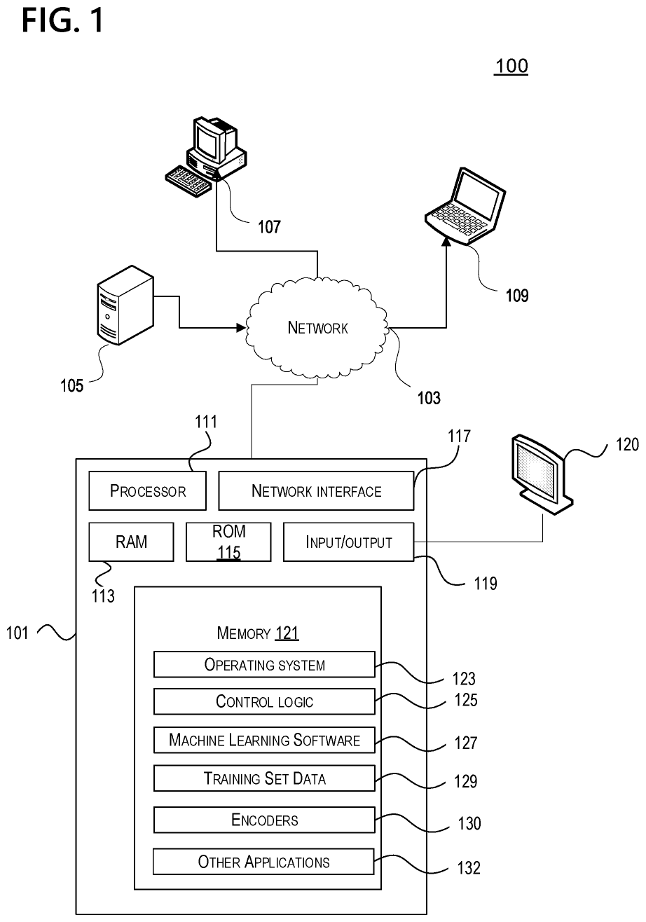

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device. Further, the computing device 101 may represent virtual reality display (VR), augment reality display (AR), heads-up display (HUD), and other electronic optical devices. Such electronic devices may be incorporated into headsets, eyeglasses, watches, and/or other wearable gear.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display, such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning model 127, training datasets 129, encoders 130, and/or other applications 132. Control logic 125 may be incorporated in and may be a part of machine learning model 127. As will be discussed in greater detail below, machine learning model 127 may include one or more of a generative adversarial network (GAN) model, a convolutional neural network (CNN) model, a recurrent neural network (RNN) model, masked language model (MLM), a random forest model, an autoencoder model, a variational autoencoder model, a synthetic data model, a deep learning architecture, an artificial neural network, or the like. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Python, Perl, or any equivalent thereof. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

The data transferred to and from various computing devices in operating environment 100 may include secure and sensitive data, such as confidential documents, user personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the operating environment 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in the operating environment 100 in front of one or more computing devices such that any external devices may communicate directly with the specialized hardware.

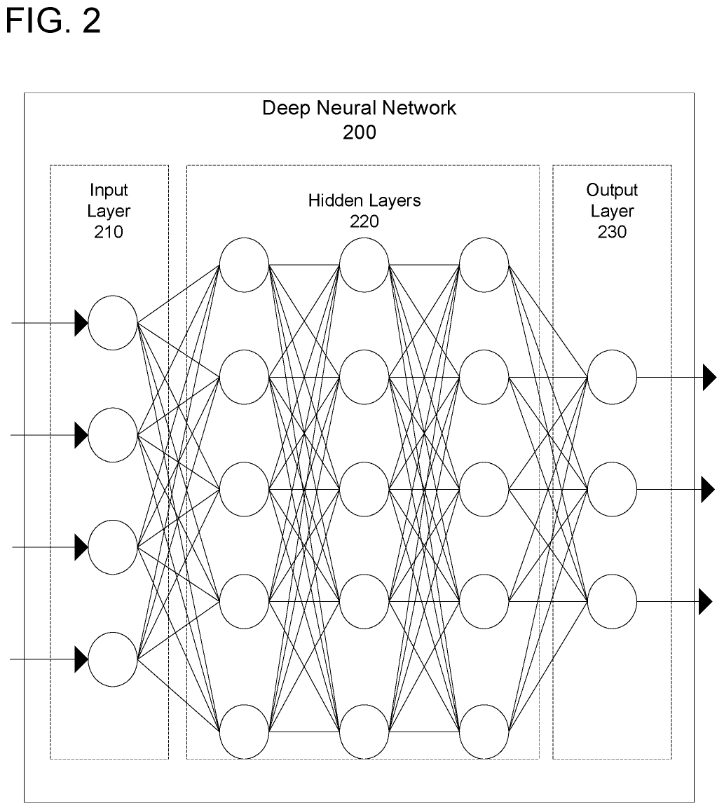

An extension, for example a browser extension (add-on, plug-in) may comprise one or more screen readers, voice recognition chat box, machine learning models, and other electronic tools to predict a user's Visually Impaired Spectrum (VIS) score. The one or more machine learning models may comprise a deep neural network, such as described further in FIG. 2 below. Additionally and/or alternatively, the one or more machine learning models may comprise one or more AI models such as generative adversarial network (GAN) models, a convolutional neural network (CNN) models, recurrent neural network (RNN) models, masked language models (MLMs), feed-forward neural networks, long short term memory (LSTM), gated recurrent units (GRUs), hidden Markov models (HMMs), regression models, correlation analysis multi-layer perceptions (MLP), random forest models, gaussian mixture models (GMMs), autoencoder models, variational autoencoder model (VAEs), k-nearest neighbors models (kNNs), k-means models, synthetic data models, support vector machine models (SVMs), deep learning architectures, any artificial neural network, or the like. The GAN model may include conditional GANs (cGAN), deep convolutional GANs (DCGAN), self-attention GANs (SAGAN), Flow-GANs, variational autoencoder GANs (VAEGAN), transformer GANs (TransGAN), or the like. Further, the machine learning model may comprise one or more of gradient descent algorithms, such as a stochastic gradient descent, differentiable generator networks, Bayesian network models, support vector machines (SVMs), logistic regression analysis, decision trees, relevance vector machines (RVMs), backpropagation methods, feed-forward methods, or the like. Regression, classification, clustering and/or decision-making algorithms may be included in the one or more machine learning models. Additionally, the machine learning model may include one or more classification models, which may be based on one or more neural network algorithms, hierarchical attention network algorithms (HAN), support vector machines (SVMs), Bayes classifiers, binary classifiers, or the like. The machine learning models may be trained by supervised learning, unsupervised learning, semi-supervised learning, or reinforcement learning structures.

A computing device may use one or more training datasets 129 to train the machine learning model 127 to generate a predicted VIS score. The one or more training datasets 129 may comprise one or more ground-truth datasets including datasets comprising user data, previously generated datasets, consumer produced datasets, and/or the like. The user data may be data associated with a current user and/or data associated with one or more other users. The other users may share the same age, educational level, employment, socioeconomic status, medical diagnosis, and/or other demographics. User data (personal information) may be acquired, for example, during opening an account, as part of a Know Your Customer (KYC) process, and/or using additional information gathering methods. Further, information for the datasets may be acquired through commercial establishments, public government databases, and/or crowdsourcing platforms. The one or more training datasets 129 may be structured, unstructured, and/or semi-structured data. The one or more training datasets 129 may be tagged to identify particular characteristics, associations, correlations, transactions, locations, and/or the like. Tagging refers to labeling and/or annotating data appropriate for the particular purpose, including machine learning datasets, classifying and organizing data, and/or the like. Tagging may include identifying one or more particular attributes and/or features of each instance of data. Additionally or alternatively, tagging may identify one or more particular attributes and/or features shared by all the instances of data in the set (e.g., identifying the metadata).

In some instances, the computing device may use a scraping algorithm to obtain information from one or more associated databases. In other examples, the computing device may use the scraping algorithm to obtain relevant information from public sources, such as the internet and social media platforms. Then the computing device may construct unique training datasets 129 from information received by the scraping algorithm. In this way, the unique training dataset 129 may be periodically updated and the machine learning model re-trained. The training datasets maybe labeled or unlabeled. The training data sets 129 may be used to train, test, refine, or retrain the machine learning model.

The one or more training datasets 129 may be produced by machine learning models, by persons, through aggregators, and/or the like. Further, the one or more training datasets 129 may be acquired from commercial establishments, public government databases, and/or crowdsourcing platforms. Additionally, the computing device may employ other types of datasets, such as validation datasets and test datasets, to fully train the machine learning model. Further, results generated from implementing a trained machine learning model may be used to either re-train or further train the machine learning model. The encoders 130 may be modal-related encoders, for example, a text encoder, an image encoder, an audio encoder, a video encoder, a transaction encoder, and/or another type of modal-specific encoders. Further, the machine learning software 127 may comprise one or more generators, such as a word embeddings generator.

FIG. 2 illustrates an example of a deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network architecture 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

Having discussed several examples of computing devices which may be used to implement some aspects as discussed further below, discussion will now turn to a method for using an extension to predict a user's Visual Impaired Spectrum (VIS) score and adjust one or more accessibility settings accordingly.

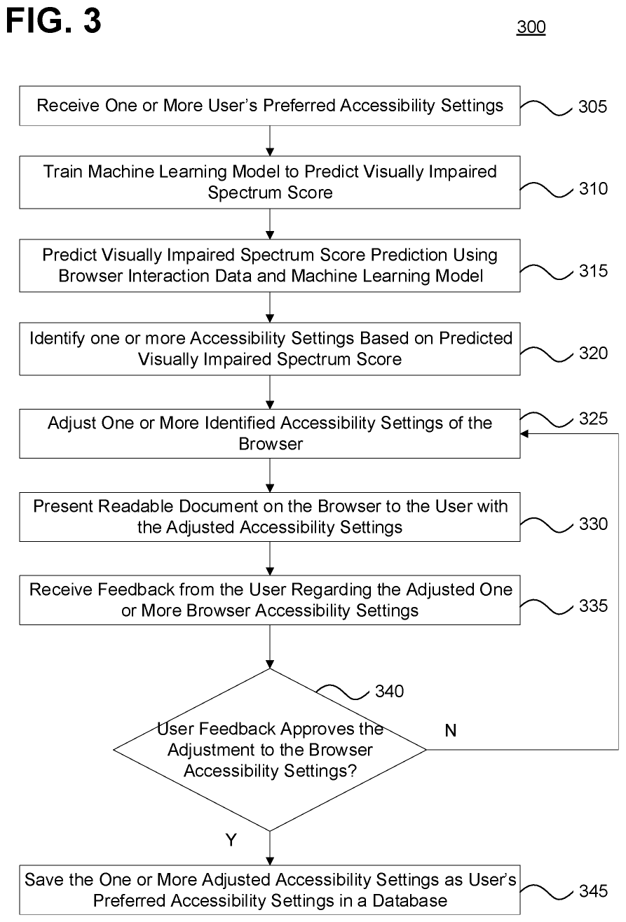

FIG. 3 depicts a flow chart for a method 300 for predicting a first visually impaired spectrum score. Method 300 may be implemented by any suitable computing device described herein, including, for example, computing devices 101, 105, 107, and/or 109.

At step 305, and after opening a browser on a website, an extension may receive one or more user's preferred accessibility settings. The extension may receive the user's preferred accessibility settings from the user directly, from an associated database, or from another information source. For example, the user may open the browser on the website and click on an extension, such as a specific VIS extension. The extension may be equipped with a voice command feature, enabling the user to audibly control the extension, through, for example, a chat box. Additionally, the extension may interact with an interface and/or Further, the website may be an authenticated website or a non-authenticated website.

The accessibility settings may comprise one or more of an auto-scrolling speed, a text-to-speech conversion rate, a font size, a font color, a font selection, a font spacing, a background color, a foreground color, a background pattern, a foreground pattern, a document lighting characteristic, a spotlight illumination characteristic, a magnification level (zoom percentage), an animation characteristic, a transparency percentage, and a tactile feedback setting. Further, the accessibility settings may include voice options for the text-to-speech function. The voice options may include gender, age, ethnicity, nationality, or other voice related options. Additionally, the accessibility settings may aid the user to see and understand text-related documents as well as image-related documents. Image-related documents may include pictures, videos, and other image data.

Once the extension is activated, the user may use their voice command to turn on or off different accessibility settings, such as auto scrolling text to speech conversion of a readable document, a transparency percentage, a magnification level, or other accessibility settings. The user may also audibly control the volume, speaker voice, lighting, or other computer setting through the extension. Further, the extension may determine the user's VIS score based, in part, on the user adjusted accessibility settings. For example, the extension may determine that the user had turned off particular accessibility settings. The extension may input this data into a trained machine learning model to determine the user's VIS score.

The extension may receive the users preferred accessibility settings through a previously submitted user survey. In addition to the user's preferred accessibility settings, the user survey may include the user's name, age, medical history, family medical history, and/or other personal information. The user may have submitted the survey during an account registration procedure, a Know Your Customer (KYC) process, and/or additional information gathering methods. In another instance, the extension may receive the user's preferred accessibility settings, as well as other personal information, when the user opens the extension. For example, after clicking on the extension, the extension may provide a chat bot, fill in page, and/or other information gathering tool, requesting the user's information. Additionally and/or alternatively, the extension may ask the user to confirm and/or update their personal information and preferences.

At step 310, the extension may train a machine learning model to predict a user's Visually Impaired Spectrum (VIS) score. The extension may train the machine learning model using the datasets as described above. Further, the extension may train model learning model employing the user's personal data and accessibility settings preferences, as described above. The machine learning model may be a structured learning model, an unstructured learning model, a conversational AI model, or other learning model.

At step 315, the extension may, using the trained machine learning model and input data, predict the user's VIS score. The extension may use, as input to the trained machine learning model, the user's personal data, the user's accessibility settings preferences, and/or other user data. Additionally, the extension may use, as input to the trained machine learning model, one or more additional users' data. The one or more additional users may share one or more demographic or medical factors of the user. The VIS score may be a number, such as a number between 1-100. The VIS score may be associated with one or more accessibility settings.

Additionally or alternatively, the extension may use, as input to a machine learning model, the user's vision diagnoses. The extension may, employing a chat box, ask the users to input their vision diagnoses. The user may vocally respond, giving their official diagnoses. Further, the user may upload medical documents to the extension. The extension may, using a natural language processing, analyze the user's documents to determine the user's medical conditions and/or diagnoses. However, if the user does not know their medical diagnosis, some time has passed since the user has seen a doctor, or the extension is unable to recognize the diagnoses, the extension may present to the user a series of assessments to determine the user's vision capabilities. During these assessments, the extension may change the browser's accessibility settings to determine the user's vision capabilities.

For example, the extension may present, to the user on the browser, different color contrasts, lighting patterns, background designs, shadings, and other light and color differentiations, in order to determine the user's contrast sensitivity, depth perceptions, glare sensitivity, color vision, night vision, contrast ability, visual acuity, light perception, pattern recognition, and other visual conditions. Additionally, the extension may display an eye chart, such as a Snellen chart, to determine if the user requires any necessary reading magnification. Further, the extension may determine each eye's characteristics. This may be done by requesting the user to use only one eye during the assessment and/or modifying the browser screen according the side used or not used. In this way, the extension may determine the visual capabilities of each user's eyes.

During the assessment, the extension may ask the user's feedback regarding any detected visual concern. For example, the extension may ask whether the particular vision capability has been constant, increasing, or decreasing in ability. In this way, the extension may determine whether the visual concern is permanent, temporary, or situational. Further, the extension may determine whether the visual concern is profound, sever, moderate, or normal, by comparing the current visual concern to a known baseline. The extension may also provide different types of light flashes, lines, shapes, patterns, and other light objects and request user feedback. The feedback may be the number of flashes, lines, shapes, patterns, and/or other light objects seen. Further, the feedback may comprise the color and/or position of the light flashes, lines, shapes, patterns, and/or other light objects. In some instances, the extension may display different features on different locations of the browser screen. Additionally, the extension may connect to a camera to determine other eye and/or vision factors. Such factors may include blinking rates, squinting amounts, head tics, exaggerated eye openings, saccadic eye movements, lazy eyes, droopy eyes, and/or other eye related traits. The extension may use the received information as input to the trained machine learning mode to predict the user's VIS score.

Further, the extension may ask for the user's personal history during the assessment. For example, the extension may ask if one or both of the user's eyes have ever been injured. Further, the extension may inquire if the user has had any brain injuries, as brain injuries may affect vision. The extension may ask the user's age and/or present tests to determine reaction time. The extension may present a list of diagnosis, syndromes, symptoms, and other medical characteristics to the user in order to determine the optimum accessibility settings for the user. For example, the extension may ask about cataract, macular degermation, glaucoma, blindness, Tourette syndrome, and/or other medical diagnosis for the user or the user's known family history. The extension may also use the received information as input to the trained machine learning mode to predict the user's VIS score.

At step 320, the extension may identify the accessibility settings associated with the user's predicted VIS score. The identified accessibility settings associated with the user's predicted score may be the optimal accessibility settings for the user. For example, the user may be in the early stages of diabetic retinopathy, suffering from blurred vision and dark areas. The VIS score may be 25, associated with a specific magnetization level. In other examples, the VIS score may be 82, indicating low peripheral vision, and associated with a particular lighting arrangement.

At step 325, the extension may adjust the browser to the one or more identified accessibility settings present. For example, the predicted VIS score may be associated with accessibility settings, such as a particular font size, 14 point, and font color, black. The extension may adjust the font size to 14 and set the font color to black, so that the document displayed to the user will be in these settings. In other instances, the predicted VIS score may be associated with accessibility settings, such as an auto-scrolling rate.

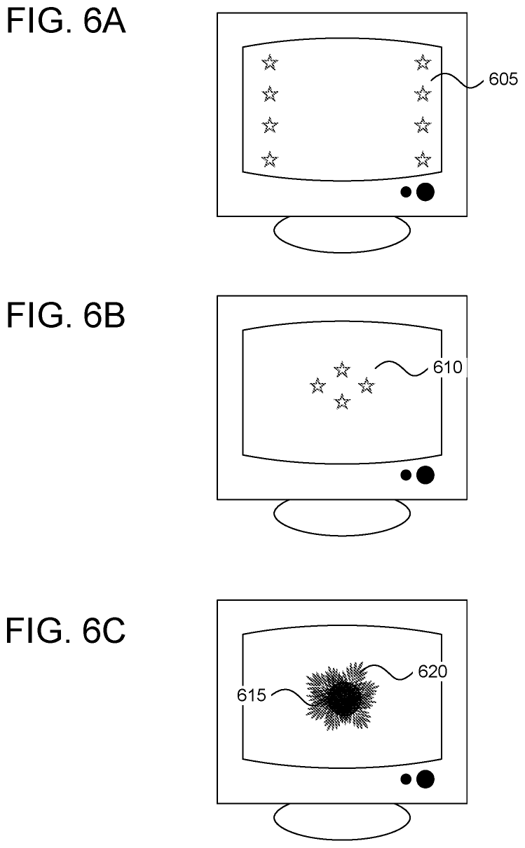

At step 330, the extension may present a readable document to the user using the one or more identified accessibility settings based on the user's predicted VIS score. For example, the predicted VIS score may indicate a low peripheral vision, as described above. The associated accessibility settings may require a particular lighting arrangement, as shown in FIG. 6A. The stars at 605, in FIG. 6A, illustrate increased peripheral lighting on the display to aid the user in reading a document. In some instances, the predicted VIS score may indicate weakening center vision. The associated accessibility settings to this user's predicted VIS score may call for a lighting arrangement as shown in FIG. 6B. The stars at 610, in FIG. 6B depict increased lighting in the center of the display.

Alternatively or additionally, at step 330, the extension may present a picture, video, or other image-related display to the user using one or more identified accessibility settings associated with the user's predicted VIS score. For example, in FIG. 6C and according to accessibility settings associated with a user's predicted VIS score, the extension may darken the center, or focal point, of the display at 615 and lighten the shading of the background of the display, at 620. Alternatively, and according accessibility settings associated with a user's predicted VIS score, the extension may darken the background of the display and lighten the shading of the center, or focal point, of the picture, video, or other image-related display. Such shading characteristics may also be employed with text data.

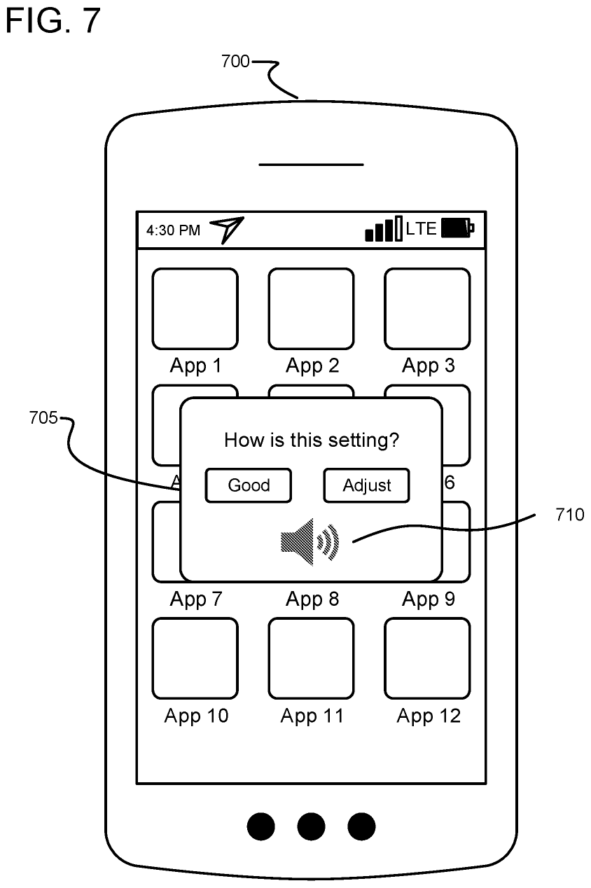

At step 335, the extension may receive feedback from the user regarding the adjusted one or more browser accessibility settings. For example, the extension may present to the user a readable document and begin a text-to-speech conversion at a rate associated with the user's VIS score. The extension may request user feedback about the rate of conversion, voice preference, volume, and other related preferences. Alternatively, the extension may use a chat box (pop-up box), as shown in FIG. 7.

At 705 in FIG. 7, the extension may ask the user for feedback regarding the current accessibility setting on the user's mobile phone 700. The request for feedback may be an audio request at 705. The user may employ the displayed buttons to respond to the request for feedback. Alternatively, the user may, at 710, vocally respond to the request for feedback. The chat box feature may be used on other electronic devices, such as laptops, tablets, computers, and the like.

For example, the user may give the extension feedback by saying “Yes, I can do this” when reading a document at a particular magnification and lighting structure. In another situation, the user may say “No, I need some help” when shown a document with a distinctive background pattern. In response, the extension may modify the background pattern and display the document again. The extension may then request further feedback from the user. The user may reply with “Show me more,” and the extension may continue modifying the background patterns until the user responds the feedback request in the affirmative. The extension may then save the user's preferences in a user profile database. The user may then, with a voice command, continue orienting to further accessibility features.

At step 340, the extension may analyze user feedback to determine whether the user approves the current accessibility setting. The extension may use a second machine learning model, trained to analyze user feedback. For example, the second machine learning model may be a natural language processing model or other machine learning model described above. The second machine learning model may be trained with the training data described above.

Based on a determination, by the second machine learning model, that the user does not approve the current accessibility setting, the extension may revert to step 325 and make one or more further adjustments to the accessibility settings. Additionally or alternatively, the extension may use the user feedback to re-train the machine learning model trained to predict the VIS score, as part of a feedback loop, in step 310, and continue the method. However, at step 340, based on a determination that the user approves the one or more accessibility settings, the method may proceed to step 345.

At step 345, the extension may save the one or more adjusted accessibility settings, as the user's preferred accessibility settings, in a database. The database may be a user profile database. Additionally, the extension may present other accessibility settings to the user and receive user feedback regarding the accessibility setting's helpfulness. In this way, the extension may develop a user's baseline preference for multiple accessibility settings for future use.

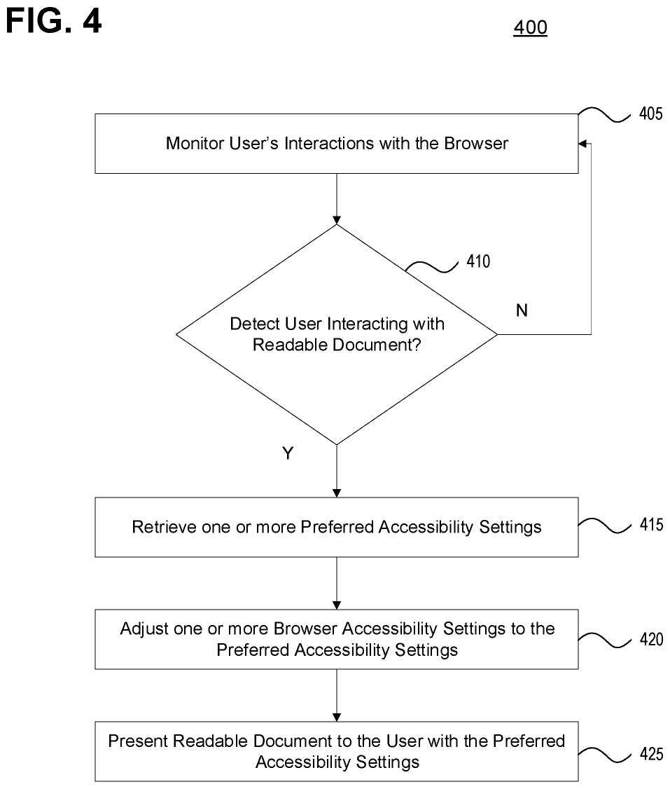

After determining and saving the user's preferred accessibility settings, at 345 in FIG. 3, the extension may then monitor the user's interaction with the browser to automatically display any readable document and/or image-based data to the user with the user's preferred accessibility settings, as described in FIG. 4. FIG. 4 depicts a flow chart for a method 400 for automatically adjusting one or more accessibility setting based on monitoring a user's interactions with a browser. Method 400 may be implemented by any suitable computing device described herein, including, for example, computing devices 101, 105, 107, and/or 109.

At step 405, the extension may monitor the user's interactions with a browser. After the user opens the browser, the extension may determine, at step 410, that the user is interacting with a readable document. At step 415, after determining that the user is interacting with a readable document, the extension may retrieve one or more preferred accessibility settings. The extension may retrieve the preferred accessibility settings from, for example, a user's profile database. At step 425, the extension may present the readable document to the user with the preferred accessibility settings. Additionally or alternatively, the extension may determine the user is interacting with an image-based document, and present the image-based document with the user's preferred accessibility settings, as shown in FIG. 7C and described above.

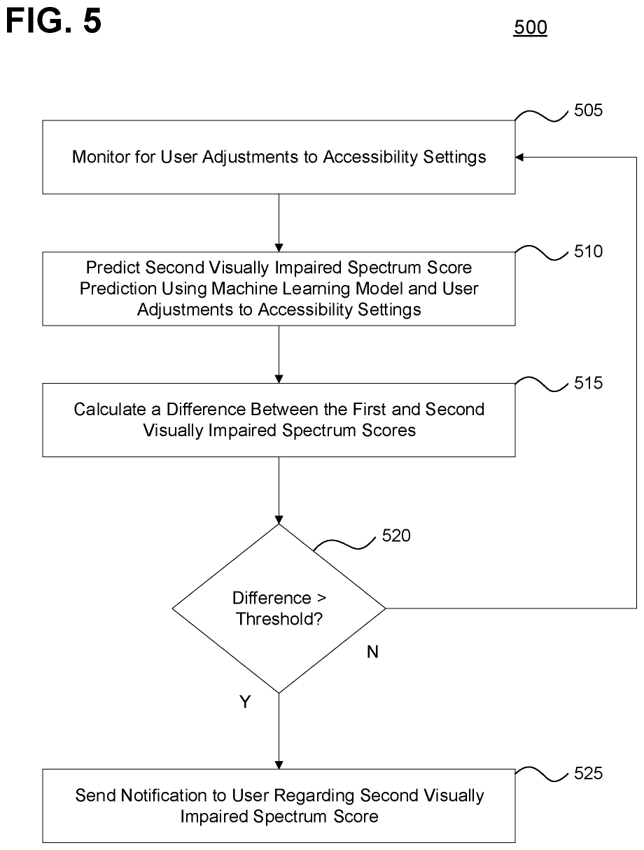

After determining that a user is interacting with a readable document, at step 410, and presenting a readable document to the user with the user's preferred accessibility settings, at step 425, the extension may monitor the user's interaction with the document, to track user changes to the user's preferred accessibility settings. The user changing the preferred accessibility settings may indicate a change to the user's visual impairment. Further, the user may not be aware that their visual impairment has altered. Therefore, the extension may predict a second VIS score, based on, at least, the user's change to the preferred accessibility settings. Further, the extension may notify the user if the difference between the first and second VIS score satisfies a threshold, as described in FIG. 5.

FIG. 5 depicts a flow chart for a method 500 for predicting a second visually impaired spectrum score. Method 500 may be implemented by any suitable computing device described herein, including, for example, computing devices 101, 105, 107, and/or 109.

At step 505, the extension may monitor a user's interaction with a readable document for user adjustments to one or more accessibility settings. The change to the accessibility settings may be made to the user's preferred accessibility settings or may be different accessibility setting. The accessibility settings may be those described above.

At step 510, the extension may predict a second VIS score, as described in FIG. 3. The extension may use, as input to the machine learning model, the user's changes to the one or more accessibility settings. After predicting a second VIS score, the extension may calculate a difference between the user's first VIS score and the user's second VIS score, at step 515. At step 520, the extension may determine if the difference between the user's first VIS score and the user's second VIS score satisfies a threshold. If the difference between the two scores fails to satisfy the threshold, the extension may revert to step 505 and continues to monitor the user's interaction with the document. However, if the extension determines, at step 520, that the difference between the user's first VIS score and the user's second VIS score satisfies a threshold, the extension may send a notification to the user at step 525. The notification may indicate that the user's VIS score has changed, which may indicate a change to the user's visual impairment. The notification may be sent via an electronic communication, such as an email, a phone message, a phone call, a text message, an SMS message, an MMS message, an instant message, a push notification, and/or the like. Additionally or alternatively, the request may be transmitted via a messaging service, a messaging application, and/or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
training, by a server and based on browser interaction data, a first machine learning model to predict a visually impaired spectrum score;
generating, by an extension implementing the first trained machine learning model, a first visually impaired spectrum score associated with a first user;
adjusting, by the extension and based on the first visually impaired spectrum score, one or more accessibility settings of a browser executing the extension;
receiving, by a second trained machine learning model, feedback from the first user regarding an adjustment to the one or more accessibility settings;
adjusting, by the extension and based on the feedback from the first user, at least one accessibility setting of the one or more accessibility settings;
storing the at least one adjusted accessibility setting; and
causing, by the browser and using the at least one adjusted accessibility setting, presentation of a readable document on the browser.

2. The method of claim 1, wherein the second trained machine learning model comprises one or more speech recognition models.

3. The method of claim 1, further comprising automatically performing, based on detecting the first user interacting with the readable document, auto-scrolling of the readable document based on the one or more adjusted accessibility settings.

4. The method of claim 1, further comprising automatically performing, based on detecting the first user interacting with the readable document, text-to-speech conversion of the readable document based on the one or more adjusted accessibility settings.

5. The method of claim 1, wherein the generating the first visually impaired spectrum score comprises:
receiving, by the extension, past user interactions indicating at least one of a preferred auto-scrolling speed for the first user or a preferred text-to-speech conversion rate for the first user; and
generating, based on the past user interactions, the first visually impaired spectrum score.

6. The method of claim 1, further comprising:
determining, by the server and based on the first visually impaired spectrum score, one or more additional accessibility settings associated with the first visually impaired spectrum score; and
adjusting, by the extension, the one or more additional accessibility settings of the browser.

7. The method of claim 6, wherein the one or more additional accessibility settings comprises one or more of:
a font size;
a font color;
a font selection;
a font spacing;
a background color;
a foreground color;
a background pattern;
a foreground pattern;
a document lighting characteristic;
a spotlight illumination characteristic;
a magnification level;
an animation characteristic;
a transparency percentage; or
a tactile feedback setting.

8. The method of claim 6, further comprising:
receiving additional feedback from the first user regarding the adjustment to the one or more additional accessibility settings;
storing, based on the additional feedback, the one or more adjusted additional accessibility settings; and
causing, by the extension and based on the additional feedback, presentation of the readable document on the browser using the one or more adjusted additional accessibility settings.

9. The method of claim 8, further comprising:
causing, by the server based on the additional feedback and the first visually impaired spectrum score, a notification to be displayed to the first user reflecting a change in the first visually impaired spectrum score.

10. The method of claim 6, further comprising: automatically performing, based on detecting the first user interacting with the readable document, the one or more adjusted additional accessibility settings.

11. A computing device comprising:
one or more processors; and
memory storing instructions that, when executed by the one or more processors, cause the computing device to:
train, based on browser interaction data, a first machine learning model to predict a visually impaired spectrum score;
generate, by an extension implementing the first trained machine learning model, a first visually impaired spectrum score associated with a first user;
adjust, by the extension and based on the first visually impaired spectrum score, one or more accessibility settings of a browser executing the extension;
receive, by a second trained machine learning model, feedback from the first user regarding an adjustment to the one or more accessibility settings;
adjust, by the extension and based on feedback from the first user, at least one accessibility setting of the one or more accessibility settings;
store the at least one adjusted accessibility setting; and
cause, by the browser and using the at least one adjusted accessibility setting, presentation of a webpage on the browser.

12. The computing device of claim 11, wherein the one or more accessibility settings comprise one or more of:
a font size;
a font color;
a font selection;
a font spacing;
a background color;
a foreground color;
a background pattern;
a foreground pattern;
a document lighting characteristic;
a spotlight illumination characteristic;
a magnification level;
an animation characteristic;
a transparency percentage;
a tactile feedback setting;
an auto-scrolling speed of the browser; or
a text-to-speech conversion rate of the browser.

13. The computing device of claim 11, wherein the instructions, when executed by the one or more processors, cause the computing device to:
automatically perform, based on detecting the first user interacting with a readable document on the webpage, auto-scrolling of the readable document based on the one or more adjusted accessibility settings.

14. The computing device of claim 11, wherein the instructions, when executed by the one or more processors, cause the computing device to:
automatically perform, based on detecting the first user interacting with a readable document on the webpage, text-to-speech conversion of the readable document based on the one or more adjusted accessibility settings.

15. The computing device of claim 11, wherein the instructions, when executed by the one or more processors comprises cause the computing device to:
receive, by the extension, past user interactions indicating at least one of a preferred auto-scrolling speed for the first user or a preferred text-to-speech conversion rate for the first user; and
generate, based on the past user interactions, the first visually impaired spectrum score.

16. The computing device of claim 11, wherein the instructions, when executed by the one or more processors comprises cause the computing device to:
determine, based on the first visually impaired spectrum score, one or more additional accessibility settings associated with the first visually impaired spectrum score; and
prompt, based on determining one or more reading aids, the first user to enable the one or more reading aids.

17. The computing device of claim 11, wherein the feedback comprises one or more of:
verbal user feedback; or
a response to a displayed prompt.

18. One or more non-transitory computer-readable media storing instructions that, when executed by one or more processors, cause a computing device to:
train, based on browser interaction data, a first machine learning model to predict a visually impaired spectrum score;
generate, by an extension implementing the first trained machine learning model, a first visually impaired spectrum score associated with a first user;
adjust, by the extension and based on the first visually impaired spectrum score, one or more accessibility settings of a browser executing the extension;
receive, by a second trained machine learning model, feedback from the first user regarding an adjustment to the one or more accessibility settings;
adjust, by the extension and based on feedback from the first user, at least one accessibility setting of the one or more accessibility settings;
store the at least one adjusted accessibility setting; and
cause, by the browser and using the at least one adjusted accessibility setting, presentation of a readable document on the browser,
wherein the generating the first visually impaired spectrum score comprises:
receiving, by the extension, past user interactions indicating at least one of a preferred auto-scrolling speed for the first user or a preferred text-to-speech conversion rate for the first user; and
generating, based on the past user interactions, the first visually impaired spectrum score.

19. The one or more non-transitory computer-readable media of claim 18, wherein the second trained machine learning model comprises one or more speech recognition models.

20. The one or more non-transitory computer-readable media of claim 18, wherein the feedback comprises one or more of:
verbal user feedback; or
a response to a displayed prompt.
